(19) United States
(12) Patent Application Publication
(10) Pub. No.: US 2006/0141310 A1
(43) Pub. Date: Jun. 29, 2006

(54) Fuel cell system and method of controlling the same

(75) Inventors: Koichiro Miyata, Utsunomiya-shi (JP); Kenichiro Ueda, Utsunomiya-shi (JP); Chihiro Wake, Shioya-gun (JP); Jumpei Ogawa, Shioya-gun (JP)

Correspondence Address: LAHIVE & COCKFIELD, 28 STATE STREET, BOSTON, MA, 02109, US

(73) Assignee: Honda Motor Co., Ltd., Minato-ku (JP)

(21) Appl. No.: 11/313,113

(22) Filed: Dec. 20, 2005

(30) Foreign Application Priority Data
Dec. 28, 2004 (JP) 2004-381013

(51) Int. Cl. H01M 8/04

(52) U.S. Cl. 429/24; 429/13

(57) ABSTRACT

A fuel cell system wherein even if the fuel cell is exposed to a cold environment, stabilization of power generation is possible. The fuel cell system comprises: a fuel cell in which electric power is generated by a reaction of reaction gases; purging means for purging at least one of reaction gas flow paths through which reaction gases flow; thermal detecting means for detecting a temperature of the fuel cell; low-temperature determining means, which determines that the temperature of the fuel cell is low every time it is below a predetermined temperature; and purging control means for purging the fuel cell when the low-temperature determining means determines, after an input of a power generation stop signal, that the temperature of the fuel cell is low.

### BACKGROUND OF THE INVENTION

1. Field of the Invention

The present invention relates to a fuel cell system which is adaptable to cold start-up, and a method of controlling the fuel cell system.

Priority is claimed on Japanese Patent Application No. 2004-381013, filed Dec. 28, 2004, the content of which is incorporated herein by reference.

2. Description of the Related Art

Recently, fuel cell-powered vehicles have been proposed, each of which includes a fuel cell system as a power source thereof. Such a known type of fuel cell includes a structure formed by stacking a predetermined number of cell units, each of which includes an anode electrode, a cathode electrode, and an electrolyte membrane sandwiched between the anode electrode and the cathode electrode. When hydrogen is supplied to the anode electrode and air (oxygen) is supplied to the cathode electrode, electrical power generation occurs through an electrochemical reaction of hydrogen and oxygen with the accompanying formation of water. During operation of the fuel cell system, water is formed mainly within the cathode electrode. A portion of the water in the cathode electrode may move to the anode electrode through the electrolyte membrane, which is placed between the cathode electrode and the anode electrode.

When the power generation of the fuel cell system is to be stopped, the formed water described above and humidifying water have a tendency to remain in gas flow paths of the fuel cell. Therefore, in a case where water remains in the fuel cell when the power generation is stopped, the remaining water may freeze at low temperature, thereby blocking supply and discharge of the reaction gases (hydrogen and air), which results in deterioration of start-up performance at low temperature.

To respond thereto, Japanese Unexamined Patent Application, First Publication No. 2003-203665 proposes a technique in which a purging operation is implemented in either one or both of the anode and the cathode, when power generation is stopped.

However, during a period of time from stoppage of power generation of the fuel cell until restarting, when the fuel cell system is exposed to a freezing environment or an equivalent cold environment, water vapor remaining in the fuel cell system easily congeals. When power generation is implemented under such conditions, problems arise in which the power generation efficiency is decreased and power generation per se is destabilized.

Further, if a purging operation is implemented every time power generation of a fuel cell is stopped, the fuel cell system is forced to operate for the purpose merely of the purging operation. The possibility arises that a passenger in a vehicle to which a fuel cell system is applied, or an operator in a stationary type electric generator to which a fuel cell system is applied, experiences a feeling of discomfort (or is burdened). This is a problem from a standpoint of commercial value.

### SUMMARY OF THE INVENTION

In consideration of the above circumstances, an object of the present invention is to provide a fuel cell system in which power generation can be stabilized even if the fuel cell is exposed to a cold environment. Another object of the present invention is to provide a fuel cell system in which a passenger and an operator do not experience a feeling of discomfort and the commercial value is improved.

In order to achieve the above object, according to a first aspect of the present invention, a fuel cell system is provided, comprising: a fuel cell in which electric power is generated by a reaction of reaction gases; purging means for purging at least one of reaction gas flow paths through which the reaction gases flow; thermal detecting means for detecting a temperature of the fuel cell; low-temperature determining means for determining that the temperature of the fuel cell is low every time it is below a predetermined temperature; and purging control means for purging the fuel cell when the low-temperature determining means determines, after an input of a power generation stop signal, that the temperature of the fuel cell is low.

Preferably, the purging control means implements purging when a predetermined period of time elapses after the input of a power generation stop signal. Further, preferably, during the previous stoppage of power generation of the fuel cell, the low-temperature determining means implements the determination. Still further, preferably, during the stoppage of power generation, the low-temperature determining means implements the determination at predetermined intervals. Yet further, preferably, when the low-temperature determining means determines that the temperature of the fuel cell is low, a flag is set up until purging is implemented, and the flag is then reset if the purging is completed.

According to a second aspect of the present invention, a method of controlling a fuel cell system is provided, which includes a fuel cell in which electric power is generated by reaction of the reaction gases, and reaction gas flow paths through which the reaction gases flow, said method comprising: detecting a temperature of the fuel cell; determining that the temperature of the fuel cell is low every time it is below a predetermined temperature; and purging at least one of the reaction gas flow paths when determining, after an input of a power generation stoppage signal, that the temperature of the fuel cell is low.

Preferably, purging is implemented when a predetermined period of time elapses after the input of the power generation stoppage signal. Further, preferably, during the previous stoppage of power generation of the fuel cell, the determination is implemented. Still further, preferably, during the stoppage of power generation, the determination is implemented at predetermined intervals. Yet further, preferably, when the temperature of the fuel cell is determined to be low, a flag is set until purging is implemented, and the flag is then reset if the purging is completed.

### BRIEF DESCRIPTION OF THE DRAWINGS

FIG. 1 is a schematic block diagram showing a fuel cell system according to an embodiment of the present invention.

FIG. 2 is a main flowchart showing a purging control process depicted in FIG. 1.

FIG. 3 is a sub flowchart showing contents of a purging routine of FIG. 2.

FIG. 4 is a sub flowchart showing contents of a process of anode purging (low-temperature anode purging, I-V anode purging) of FIG. 3.

FIG. 5 is a graphical view showing time variations of an ECU, a fuel cell temperature, the presence of power generation, the presence of an anode purging, the presence of a low-temperature environment, etc.

### DESCRIPTION OF THE PREFERRED EMBODIMENTS

With reference to the drawings, a fuel cell system according to an embodiment of the present invention will be described hereinafter.

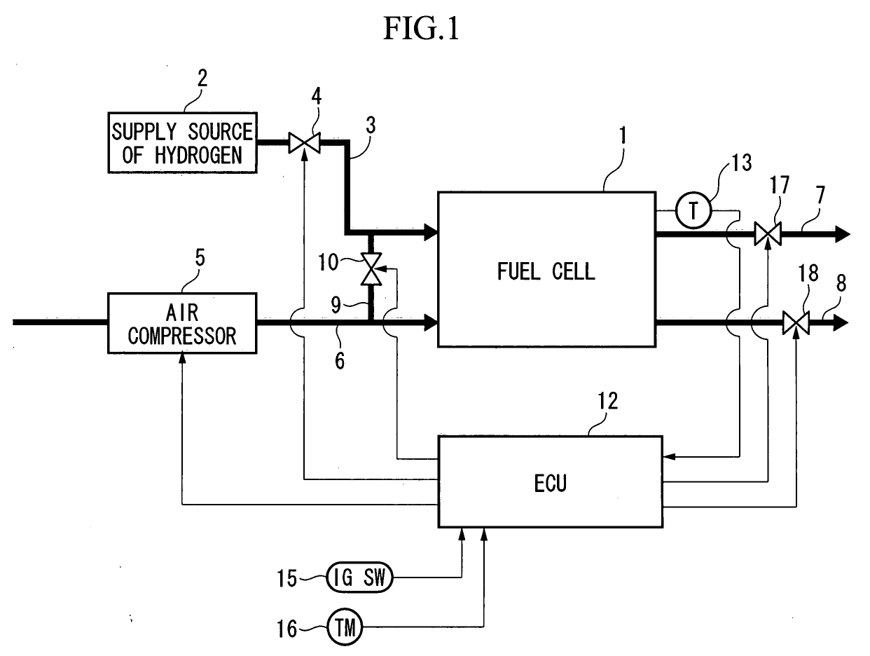

FIG. 1 is a schematic block diagram showing the fuel cell according to the present embodiment.

A fuel cell 1 is formed by stacking a plurality of cells, each of which includes an anode, a cathode, and a solid polymer electrolyte membrane (e.g., a solid polymer ion-exchange membrane) sandwiched between the anode and the cathode.

In the fuel cell 1 thus structured, hydrogen as a fuel gas is supplied to the anode, and air containing oxygen as an oxidizing gas is supplied to the cathode. Due to this, at the anode, catalytic reaction produces hydrogen ions, which reach the cathode through the electrolyte membrane, and at the cathode the hydrogen ions electrochemically react with oxygen to thereby produce electrical power and form water. At this time, part of the generated water formed in the cathode back-diffuses into an anode side through the electrolyte membrane, and therefore, water exists also in the anode side.

A hydrogen gas supplied from a supply source of hydrogen (e.g., a hydrogen tank) 2, is forwarded to the anode of the fuel cell 1 through a shut-off valve 4 and through a hydrogen gas supply path 3.

On the other hand, air is pressurized by an air compressor 5 and supplied through an air supply path 6 to the cathode of the fuel cell 1.

The hydrogen gas supply path 3 and the air supply path 6 are connected via a connecting path 9. An on-off valve 10 is provided on the connecting path 9. By controlling opening and closing of the on-off valve 10, merging of reaction gases (i.e., hydrogen and air) flowing through respective paths 3 and 6 can be allowed or prevented.

The hydrogen gas and the air supplied to the fuel cell 1 are used for power generation. Thereafter, they are forwarded as off-gases from the fuel cell 1 to their respective discharge paths, i.e., a hydrogen gas discharge path 7 and an air discharge path 8, together with residual water, e.g., water generated in the anode area.

A hydrogen purging valve 17 and an air purging valve 18 are provided on the hydrogen gas discharge path 7 and the air discharge path 8, respectively. When the purging valves 17 and 18 are opened, the residual water, air and reacted hydrogen as off-gases, are discharged through the air discharge path 8 and the hydrogen gas discharge path 7, respectively. Note that the hydrogen discharged from the hydrogen gas discharge path 7 is diluted to or below a predefined concentration level in an unillustrated dilution box, of which further details thereof are omitted.

A controller (ECU) 12, which controls various types of equipment, is provided in the fuel cell system. An ignition switch (IG SW) 15 and a timer (TM) 16 are connected to the ECU 12. From these, signals including an ignition-on (IG-ON) signal and an ignition-off (IG-OFF) signal, and signals indicating times of measurement are inputted to the ECU 12.

Further, a temperature sensor 13 is connected to the fuel cell 1. The temperature T measured by this temperature sensor 13 is inputted to the ECU 12.

Then, the ECU 12 outputs signals to drive the air compressor 5, the shut-off valve 4, the on-off valve 10, and the purging valves 17 and 18, in accordance with those signals and data measured.

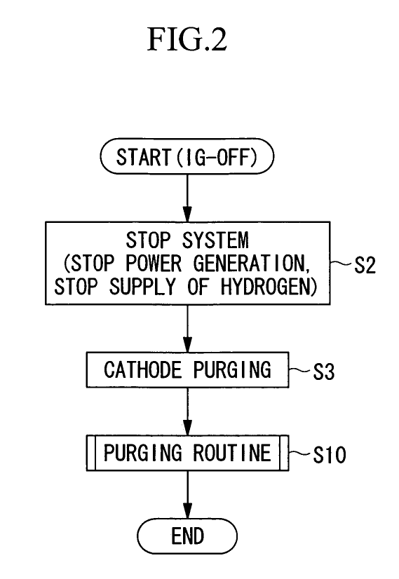

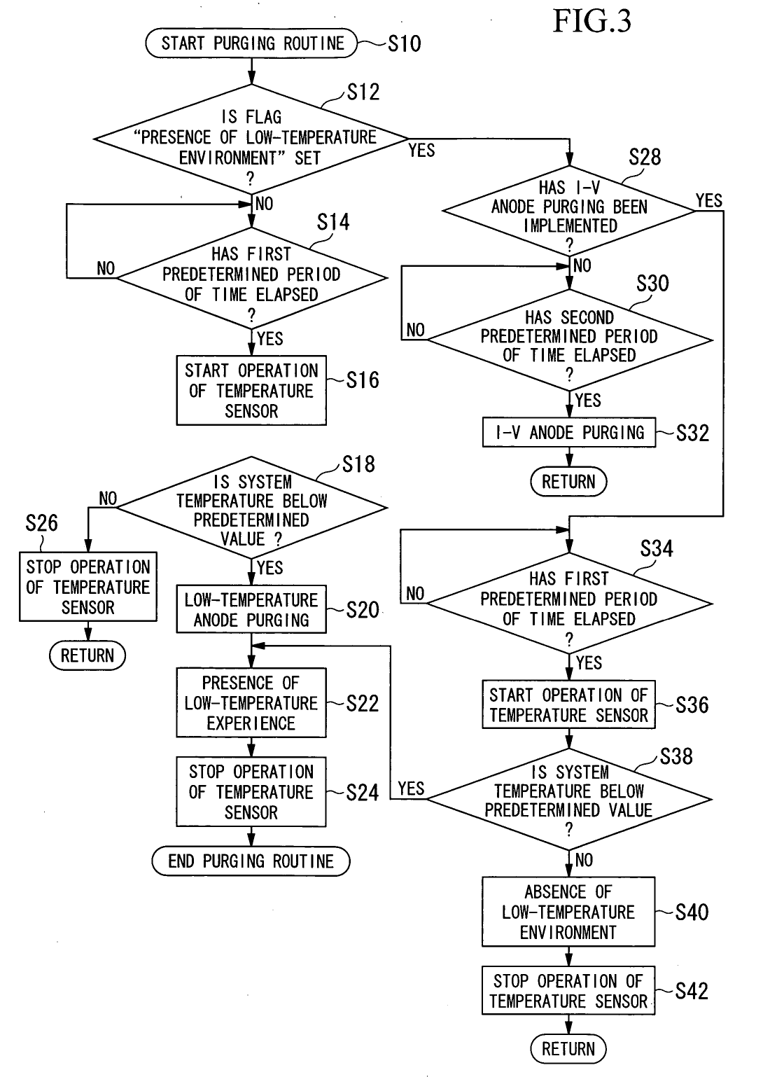

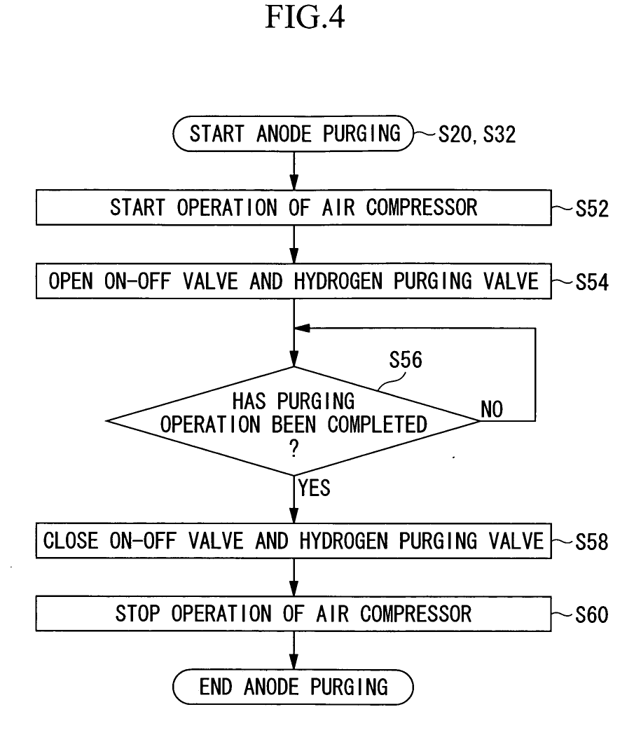

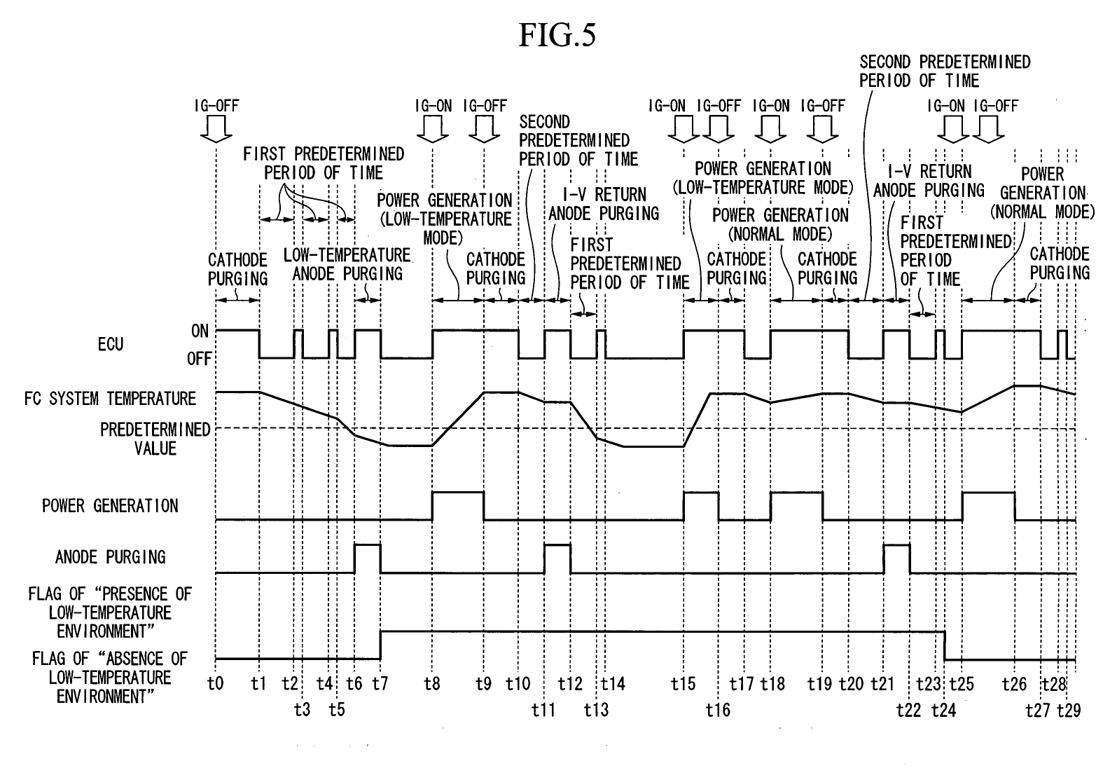

Operation of the fuel cell system structured as above-described will be explained with reference to FIGS. 2 through 5. FIG. 2 is a main flowchart showing a purging control process depicted in FIG. 1. FIG. 3 is a sub flowchart showing contents of a purging routine of FIG. 2. FIG. 4 is a sub flowchart showing contents of a process of anode purging (low-temperature anode purging, I-V anode purging) of FIG. 3. FIG. 5 is a graphical view showing time variations of an ECU, a fuel cell temperature, the presence of power generation, the presence of an anode purging, the presence of low-temperature environment, etc.

In the first place, referring to FIG. 2, as can be seen from the same figure, when the ECU 12 detects that the ignition switch 15 is turned OFF, the power generation operation of the fuel cell 1 is stopped in step S2. Specifically, the shut-off valve 4 of the hydrogen gas supply path 3 is closed so that the supply of reaction gas to the fuel cell 1 is stopped. Then, in step S3, purging of the cathode is started. Namely, the air compressor 5 is driven for operation and the air purging valve 18 is opened such that purging of the cathode route of the fuel cell 1 (i.e., the cathode, the air supply path 6, and the air discharge path 8, of the fuel cell 1) is carried out. The reason that such cathode purging is carried out after a system stoppage is because produced water is produced mainly in the cathode according to the nature of a power generation reaction of the fuel cell 1. Then, in step S10, operations of a purging routine are carried out. Details thereof will be described hereinafter with reference to FIG. 3.

Firstly, in step S12, it is determined whether a flag indicating “the presence of low-temperature environment” is set. When the result of the determination is “YES”, the operation proceeds to step S28, and when the result is “NO”, the operation proceeds to step S14. Note that, in the initial state of the fuel cell 1 (namely, before a flag indicating “the presence of low-temperature environment” is set in step S22, details of which will be described later), a flag indicating “the absence of low-temperature environment” is set, and therefore, the operation necessarily proceeds to step S14.

In step S14, whether or not a predetermined period of time elapses is determined. Note that, in order to distinguish said predetermined period of time from a predetermined period of time of an after-mentioned step S30, said predetermined period of time is referred to as the “first predetermined period of time” for convenience. When the result of the determination is “YES”, the operation proceeds to step S16, and when the result is “NO”, the operation returns to step S14. In other words, the operation of step S14 is repeated up until the first predetermined period of time elapses.

In step S16, the temperature sensor 13 is operated to measure the temperature of the fuel cell 1. Incidentally, although in this embodiment the temperature sensor 13 is independently provided and connected to the fuel cell 1, the fuel cell 1 can incorporate therein the temperature sensor 13. Further, the temperature sensor 13 can be connected to the reaction gas flow path (the hydrogen gas discharge path 7, the air discharge path 8, etc.). Furthermore, the temperature sensor 13 can be connected to a cooling medium flow path to cool off the fuel cell 1.

In step S18, whether or not the temperature of the fuel cell 1 drops is determined. This determination is made by judging whether or not the temperature detected by the temperature sensor 13 is below a predetermined value (e.g., 5° C.). When the result of this determination is “YES”, the operation proceeds to step S20, and when the result of the determination is “NO”, the operation proceeds to step S26.

In step 20, the process of anode purging is carried out (which is hereinafter referred to as “low-temperature anode purging”). Details of this low-temperature anode purging will be described later with reference to FIG. 4. Then, as described above, by setting the predetermined temperature value of step 18 to a certain temperature which is somewhat above freezing point, freezing of the residual water can be prevented, and at the same time, a major part of vapor water remaining within the fuel cell system can condense, and therefore, the purging process can be carried out in such a state. In step S22, a flag indicating “the presence of low-temperature environment” is set. Thereafter, in step S24, operation of the temperature sensor 13 is stopped, and then, the purging routine that is the process of the main flowchart is stopped. Namely, the process of FIG. 2 is terminated.

On the other hand, when the result of the determination of step S18 is “YES”, i.e., when the temperature of the system is above the predetermined value, the operation proceeds to step S26, where operation of the temperature sensor 13 is stopped, and then, the operation returns to step 10, i.e., the first step or process of the flowchart.

Incidentally, after a flag indicating “the presence of low-temperature environment” is once set, if the purging routine of FIG. 3 is started, the result of the determination of step S12 is then “YES” and the operation proceeds to step S28. In step S28, whether or not an I-V anode purging has already been carried out is determined. When the result of this determination is “YES”, the operation proceeds to step S34, and when the result of the determination is “NO”, the operation proceeds to step S30. Note that the “I-V anode purging” is a process of purging which is implemented for stable power generation in step S32 and which will be described later. Therefore, at the initial state of the fuel cell 1, the result of the determination of step S28 becomes “NO”, and then, the operation proceeds to step S30.

In step S30, whether or not the predetermined period of time elapses is determined. Note that, in order to distinguish said predetermined period of time of step S30 from the (first) predetermined period of time of step 14, said predetermined period of time of step S30 is referred to as the “second predetermined period of time”. When the result of the determination is “YES”, the operation proceeds to step S32, and when the result of the determination is “NO”, the operation returns to step S30. In other words, the operation of step S30 is repeated until the second predetermined period of time elapses. Additionally, the first predetermined period of time is a time which is set according to the system temperature of the fuel cell 1, wherein when the system temperature of the fuel cell 1 is high, the first predetermined period of time is set to be long, on the assumption that it will take a long time for the system temperature of the fuel cell 1 to drop below a preselected temperature, and wherein when the system temperature of the fuel cell 1 is low, the first predetermined period of time is set to be short, on the assumption that it will take a short time for the system temperature of the fuel cell 1 to drop below the preselected temperature. The second predetermined period of time is a time during which an operator or a passenger can be considered to have left the fuel cell system 1.

In step S32, for stable power generation anode purging is implemented (which is referred to as “I-V anode purging”). By implementing this I-V anode purging, the power generation operation of the fuel cell 1 is made stable whereby power generation efficiency can be promoted. In other words, if the fuel cell system is once exposed to such a cold environment, water remaining in the fuel cell system easily congeals (accumulates), which, in turn, becomes an obstacle to stabilization of power generation, thus decreasing the power generation efficiency. To respond thereto, by implementing the I-V anode purging and by purging the accumulated water, it is possible to stabilize power generation and to promote power generation efficiency. After executing the operation of step S32, the operation returns to the first step or process of the flowchart (or step S10).

The anode purging operation will be described with reference to FIG. 4. Firstly, in step S52, the air compressor 5 is driven for operation. Next, in step S54, the on-off valve 10 is opened such that compressed air from the air compressor 5 is supplied through the connecting path 9 and then through the hydrogen gas supply path 3 to the anode of fuel cell 1. At the same time, the hydrogen purging valve 17 is opened such that air flowing out from the anode of the fuel cell 1 is discharged from the hydrogen gas discharge path 7. Then, in step S56, whether or not the purging operation is completed is determined. When the result of this determination is “YES”, the operation proceeds to step S58, and when the result of the determination is “NO”, the operation returns to step S56. Determination of completion of purging can be made by the use of a timer or can be made in accordance with a differential pressure between the hydrogen gas supply path 3 and the hydrogen gas discharge path 7. In other words, it can be estimated that when the differential pressure between the hydrogen gas supply path 3 and the hydrogen gas discharge path 7 is below a fixed value, residual water which is responsible for obstruction of the paths in the fuel cell 1 is discharged. Now, in step S58, the on-off valve 10 and the hydrogen purging valve 17 are respectively closed, and, in step S60, the air compressor 5 is stopped, and then the operations in the anode purging routine are terminated. Note that the above-described low-temperature anode purging of step S20 is implemented in the same way.

Further, when the result of the determination in step S28 is “YES”, i.e., when it is determined that the I-V anode purging has been completed, the operation proceeds to step S34, where whether or not the first predetermined period of time has elapsed is determined. When the result of this determination is “YES”, the operation proceeds to step S36, and when the result of the determination is “NO”, the operation returns to step S34.

In step S36, the temperature sensor 13 is operated to measure the temperature of the fuel cell 1. Then, like step 18, step S38 determines whether or not the temperature of the fuel cell has dropped. When the result of this determination is “YES”, the operation proceeds to step S22, where the above-mentioned operation is implemented. On the other hand, when the result of the determination is “NO”, the operation proceeds to step S40, where a flag indicating “the absence of low-temperature environment” is set. At the same time, the flag indicating “the presence of low-temperature environment” is reset. Thereafter, in step S42, operation of the temperature sensor 13 is stopped, and then, the purging routine that is the process of the main flowchart is stopped. Namely, the process of FIG. 2 is terminated. During the period in which the processes of FIGS. 2 and 3 are stopped, the flag indicating “the I-V anode purging completed” is reset when changed into a state of IG-ON. In other words, after this flag has been reset, until an I-V anode purging operation is again implemented, the result of the determination of step S28 is maintained to be “NO”.

Control thereof will be described hereinafter with reference to FIG. 5. Note that the processes depicted in this figure are a series of examples, and the present invention is by no means limited thereto. When a signal indicating an IG-OFF state is inputted to the ECU 12 (time t0), the ECU 12 controls the cathode purging of step S3 and stops the power generation operation. Then, operations of related devices except the ECU 12 and the timer are stopped (time t1). Further, after the first predetermined period of time has elapsed, the ECU 12 is activated to place the temperature sensor 13 in operation. When a temperature detected at this time is above the predetermined temperature, operation of the temperature sensor 13 is stopped and the ECU 12 is also stopped (time t2-t5).

On the other hand, when such a temperature detected by the temperature sensor 13 is on or below the predetermined temperature (time t6), the low-temperature anode purging operation of step S20 is implemented, and after completion of this purging operation, a flag indicating “the presence of low-temperature environment” is set (time t7).

Thereafter, when a signal indicating an IG-ON state is inputted to the ECU 12 (time t8), the purging operation is interrupted and the ECU 12 operates related devices and starts a start-up operation of power generation. This start-up is implemented in a low-temperature mode. The low-temperature mode is different from an after-mentioned normal mode with respect to, for example, increase of anode pressure, increase of cathode operation pressure, increase of cathode flow, etc. Then, when a signal indicating an IG-OFF state is inputted to the ECU 12 (time t9), the ECU 12 controls the cathode purging of step S3 and stops the power generation operation. Then, operations of related devices except the ECU 12 and the timer are stopped (time tlo).

After the second predetermined period of time has elapsed, the ECU 12 is activated and an I-V return anode purging operation is implemented (time t12). After the first predetermined period of time has elapsed, the ECU 12 is again activated to place the temperature sensor 13 in operation (time 13-14). At this time, as the temperature of the fuel cell system is on or below the predetermined temperature, the flag indicating “the presence of low-temperature environment” is maintained without change.

When a signal indicating an IG-ON state is inputted to the ECU 12 (time t15), the purging operation is interrupted and the ECU 12 operates related devices and starts a start-up operation of power generation. This power generation is implemented in a low-temperature mode. Thereafter, when a signal indicating an IG-OFF state is inputted to the ECU 12 (time t16), the ECU 12 controls the cathode purging of step S3 and stops the power generation operation. Then, operations of related devices except the ECU 12 and the timer are stopped (time t17). Then, before the first predetermined period of time elapses, when a signal indicating an IG-ON state is inputted to the ECU 12 (time t18), the purging operation is interrupted and a start-up operation of power generation is started. This power generation is implemented in a normal mode because the temperature of the system is higher than the predetermined temperature at a time of a start-up operation of power generation. On the other hand, when the system temperature is lower than the predetermined temperature, the power generation is implemented in a low-temperature mode. Next, when a signal indicating an IG-OFF state is inputted to the ECU 12 (time t19), the ECU 12 controls the start of the cathode purging of step S3 and stops the power generation operation. Then, operations of related devices except the ECU 12 and the timer are stopped (time t20).

After the second predetermined period of time has elapsed (time t21), the ECU 12 is activated and an I-V return anode purging operation of step S32 is implemented (time t22). After the first predetermined period of time has elapsed, the ECU 12 is again activated to place the temperature sensor 13 in operation (time 23-24). At this time, as the temperature of the fuel cell system is above the predetermined temperature, a flag indicating “the absence of low-temperature environment” is set.

Thereafter, when a signal indicating an IG-ON state is inputted to the ECU 12 (time t25), the purging operation is interrupted and the ECU 12 operates related devices and starts an operation of power generation. This power generation is implemented in a normal mode. Then, when a signal indicating an IG-OFF state is inputted to the ECU 12 (time t26), the ECU 12 controls the cathode purging of step S3 and stops the power generation operation. Operations of related devices except the ECU 12 and the timer are stopped (time t27). After the first predetermined period of time has elapsed, the ECU 12 is activated to place the temperature sensor 13 in operation such that the temperature of the fuel cell system is detected (time t28-29).

Note that, of course, the present invention is not limited to the above-mentioned embodiment. For example, the present fuel cell system can be applied to a vehicle or an electric generator of stationary type. Additionally, provision in which a purging operation is implemented after a predetermined period of time elapses in such a manner as described in step S30 is preferable, because it is possible to remove any burden on (or a sence of discomfort of) an operator or a passenger, thus improving commercial value. However, it may be preferable to immediately implement a purging operation in step S32 without a predetermined waiting time (namely, with the second predetermined period of time set zero). Further, although, in the present embodiment, a cathode purging operation is necessarily implemented at any time when a signal indicating an IG-OFF state is inputted, it may be preferable to implement it at the same timing as that of anode purging. Furthermore, a purging means according to the present invention may be one which purges any one of an anode and a cathode.

What is claimed is:

1. A fuel cell system, comprising:
a fuel cell in which electric power is generated by a reaction of reaction gases;
purging means for purging at least one of reaction gas flow paths through which reaction gases flow;
thermal detecting means for detecting a temperature of the fuel cell;
low-temperature determining means for determining that the temperature of the fuel cell is low every time it is below a predetermined temperature; and
purging control means for purging the fuel cell when the low-temperature determining means determines, after an input of a power generation stop signal, that the temperature of the fuel cell is low.

2. The fuel cell system according to claim 1, wherein the purging control means implements purging when a predetermined period of time elapses after the input of the power generation stop signal.

3. The fuel cell system according to claim 1, wherein, during the previous stop of power generation of the fuel cell, the low-temperature determining means implements a determination.

4. The fuel cell system according to claim 3, wherein, during the stoppage of power generation, the low-temperature determining means implements the determination at predetermined intervals.

5. The fuel cell system according to claim 1, wherein when the low-temperature determining means determines that the temperature of the fuel cell is low, a flag is set until purging is implemented, and the flag is then reset if the purging is completed.

6. A method of controlling a fuel cell system which includes a fuel cell in which electric power is generated by a reaction of reaction gases, and reaction gas flow paths through which reaction gases flow, said method comprising:
detecting a temperature of the fuel cell;
determining that the temperature of the fuel cell is low every time it is below a predetermined temperature; and
purging at least one of reaction gas flow paths when determining, after an input of a power generation stoppage signal, that the temperature of the fuel cell is low.

7. The method according to claim 6, wherein purging is implemented when a predetermined period of time elapses after the input of the power generation stop signal.

8. The method according to claim 6, wherein, during the previous stoppage of power generation of the fuel cell, a determination is implemented.

9. The method according to claim 8, wherein, during the stop of power generation, the determination is implemented at predetermined intervals.

10. The method according to claim 6, wherein when the temperature of the fuel cell is determined to be low, a flag is set until purging is implemented, and the flag is then reset if the purging is completed.
